(19) United States
(12) Patent Application Publication
(10) Pub. No.: US 2006/0129970 A1
(43) Pub. Date: Jun. 15, 2006

(54) Systems and methods for production planning analysis using discrete event simulation

(76) Inventors: Martin C. Haas, Hudson, OH (US); Robert J. Schreiber, St. Louis, MO (US); Thomas G. Stauder, Belleville, IL (US)

Correspondence Address: BLACK LOWE & GRAHAM PLLC, 701 FIFTH AVENUE, SUITE 4800, SEATTLE, WA, 98104, US

(21) Appl. No.: 11/012,901

(22) Filed: Dec. 15, 2004

(51) Int. Cl. G06F 9/44

(52) U.S. Cl. 717/104; 717/135

(57) ABSTRACT

The present invention comprises systems and methods for production planning analysis using discrete event simulation methods. In one embodiment, a system includes a first software module to receive process definition data for the production process that organizes the data into a suitable formatted input file that defines the process. A second software module performs a discrete event simulation on the input file and generates an output file. A third software module generates at least one user accessible file from the output file. In another embodiment, a method of analyzing a manufacturing process includes receiving process definition data for the manufacturing process, and generating an input file from the process definition data. The method further includes processing the input file in a discrete event simulation (DES) engine to generate selected statistical data for the process, and generating an output file that includes the selected statistical data.

### FIELD OF THE INVENTION

This invention relates generally to information technology, and more particularly, to systems and methods for production planning and resource allocation analysis using stochastic simulation methods.

### BACKGROUND OF THE INVENTION

Complex projects such as the planning and construction of large commercial or tactical aircraft require the scheduling and coordination of a plurality of resources. The resources to be coordinated may include materials, component parts, personnel, machinery and factory floor space, in addition to other resources. Scheduling and coordination is particularly important in complex projects since factors such as the overall cost of the project, the time required for completion of the project, and the risk of failure must be accurately estimated. In addition, other variables of importance such as the overall efficiency of the project need to be accurately estimated. For example, a determination as to whether one or more resources will be underutilized or even idle for a significant amount of time needs to be accurately determined.

In known scheduling analysis methods, the scheduling process generally begins with input data that defines task dependencies and estimated task durations. Task dependencies generally express relationships between various tasks, so that the various tasks may be properly ordered. For example, in the construction of large commercial aircraft, a material such as an aluminum sheet material must be procured before fuselage panels may be fabricated. Computational codes and equipment may then be used to process the input data to arrange the various tasks into an ordered set. Accordingly, in most cases, a multiplicity of different paths result from processing the input data, which may include one or more critical paths. The critical path constitutes the path having the longest duration in the ordered set exhibiting the least slack time. Accordingly, it is the path along which no delay in the provision of a necessary resource may occur without delaying the entire project, and is thus of central importance in project planning. The manufacturing process may therefore be analyzed based upon relationships between the various individual tasks comprising the process, and upon a critical path for the process. As resource delays occur, the critical path may shift from a first task set to another task set. Accordingly, the critical path is not fixed, and may change.

Although existing process planning and analysis methods are useful, they nevertheless exhibit several drawbacks, and thus may not accurately represent a selected process. Existing methods generally do not permit variability in tasks or resources in the process to be effectively analyzed. Variability is naturally present in most real processes, which may be manifested in the form of machine reliability, or other similar variabilities. In particular, the effect of changes in the critical path are not easily captured in the existing methods.

What is needed in the art are process planning and analysis systems and methods that permit realistic simulation of a production process, so that production planning may be more accurately forecast.

### SUMMARY OF THE INVENTION

The present invention comprise systems and methods for production planning and analysis using discrete event simulation methods. In one aspect of the invention, a system includes a first software module operable to receive process definition data for the production process and configured to organize the data into a suitable formatted input file that defines the process. A second software module performs a discrete event simulation on the input file and generates an output file. A third software module is operable to generate at least one user accessible file from the output file.

In another aspect, a method of analyzing a manufacturing process includes receiving process definition data for the manufacturing process, and generating an input file from the process definition data. The method further includes processing the input file in a discrete event (DES) simulation engine to generate selected statistical data for the process, and generating an output file that includes the selected statistical data.

### BRIEF DESCRIPTION OF THE DRAWINGS

The preferred and alternative embodiments of the present invention are described in detail below with reference to the following drawings.

FIG. 1 is a block diagrammatic view of a system for analyzing a production process according to an embodiment of the invention; and

FIG. 2 is a flowchart that will be used to describe a method of analyzing a manufacturing process according to another embodiment of the invention.

### DETAILED DESCRIPTION OF THE INVENTION

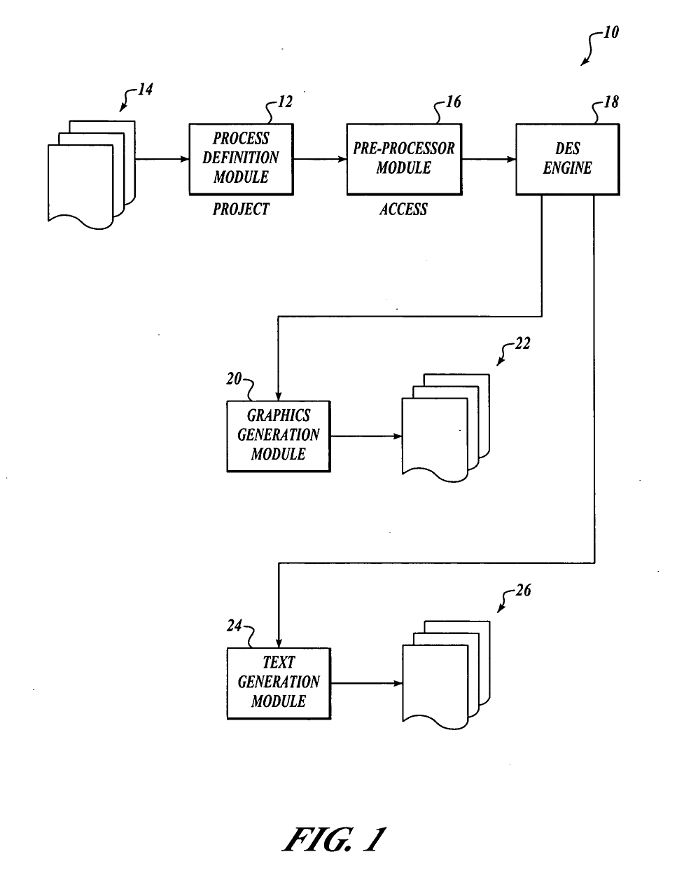

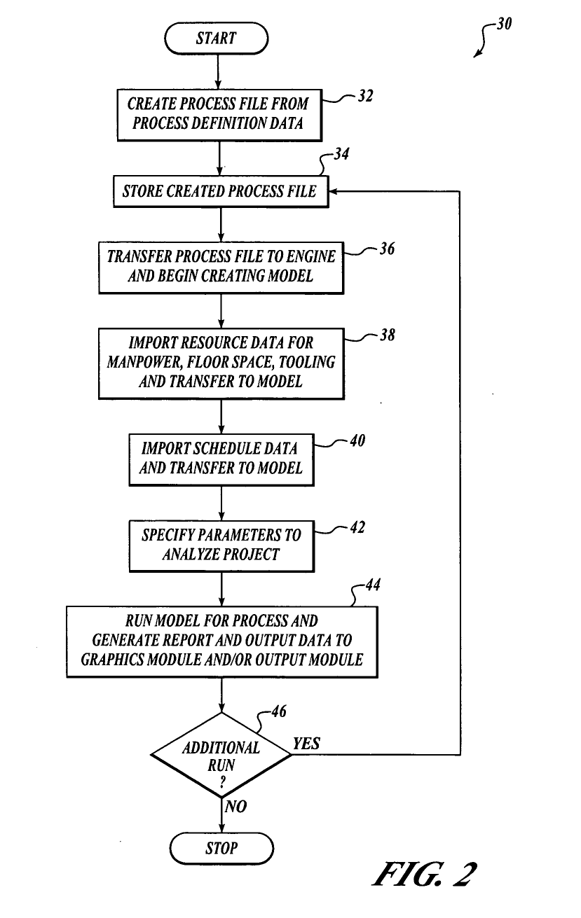

The present invention relates to systems and methods for production process planning and resource allocation analysis using discrete event simulation. Many specific details of certain embodiments of the invention are set forth in the following description and in FIGS. 1 and 2 to provide a thorough understanding of such embodiments. One skilled in the art, however, will understand that the present invention may have additional embodiments, or that the present invention may be practiced without several of the details described in the following description.

FIG. 1 is a diagrammatic block view of a system 10 for analyzing a production process according to an embodiment of the invention. The system 10 includes a plurality of software modules that cooperatively generate analytical information concerning a planned process. In one embodiment, the software modules in the system 10 may be executed using a programmable computer such as a personal computing device using a WINDOWS 95, WINDOWS 98. WINDOWS 2000 or WINDOWS NT version 4.0 operating system and having at least a PENTIUM processor that operates at an internal clock rate of 100 Mhz and having access to at least 32 Megabytes (MB) of internal random access memory (RAM). In an alternate embodiment, however, the personal computing device includes a PENTIUM II processor having at least 64 MB of RAM. More specifically, the system 10 includes a pre-processor module 12 that receives process definition data 14. And operating system maybe operable to support various operator interfaces for submitting and/or retrieving information generated by the system 10, and to further permit the operator to control the operation of the system 10. The operator interfaces will be described in further detail below.

The process definition data 14 may be comprised of one or more informal precedence networks that describe a particular production process, or it may include other collections of project information that are used to define the process. The process definition data 14 may be provided to the system 10 through an input/output interface (not shown) such as a display terminal and a keyboard that is coupled to the programmable computer, in cases where the information is present in the form of written documents that require manual data entry, or it may be provided to the system 10 through a removable memory device such as a magnetic or optical disk so that the data 14 is introduced to the programmable computer by means of a suitable drive that is coupled to the programmable computer. In either case, the process definition module 12 is configured to organize the data 14 into a suitable format that includes, for example, shift requirements, shift resources, resource pools and machine parameters, and other similar information. The module 12 also verifies, for example, that the data 14 includes a starting point and an end point for the process, and that all other tasks associated with the process have predecessor and successor relationships. The process definition module 12 also organizes various task level resources, including manpower, tooling requirements, work areas or zones and other pertinent resources into respective data fields. In one particular embodiment, the process definition module 12 may include the Microsoft PROJECT software package, available from the Microsoft Corporation of Redmond, Wash., although other suitable alternatives exist.

The system 10 also includes a pre-processor module 16 that receives the appropriately formatted precedence chart information from the process definition module 12. The pre-processor module 16 transforms the precedence chart information into a flat data file structure so that the precedence chart information may be transferred to subsequent modules. The flat data file structure is accordingly populated with information extracted from the precedence charts. In another particular embodiment of the invention, the pre-processor module 16 may include the Microsoft ACCESS software package, also available from the Microsoft Corporation of Redmond, Wash., although other suitable alternatives exist.

Following appropriate formatting of the data 14 in the process definition module 12 and the pre-processor module 16, the flat file data structure is transferred to a discrete event simulation (DES) engine 18 operable to compile a simulation model for the specified process and to subject the model to a discrete event simulation. Discrete event simulation is a known method that allows the time-based behavior of a dynamic system to be observed. Briefly and in general terms, a simulation model is comprised of one or more entities that are linked by logic statements. Entities are the tangible elements that exist in the model, such as a part or a subassembly of a product that passes through a production process. Alternately, the entity may be a machine that processes the particular part or subassembly. Accordingly, the entities may be temporary, such as the part or subassembly that passes through the production process, or it may be permanent, such as a machine that processes the part or subassembly. Logic statements define an act that the entity will perform, and are thus a critical part of the simulation process since they define an overall behavior of the model. For example, a common logic statement in a simulation model may be expressed as an instruction to start a selected machine (a permanent entity) if one or more parts or subassemblies (a temporary entity) is waiting in a queue to be processed by the selected machine.

A discrete event simulation may include a simulation executive that defines the time-based control that governs the simulation, and also controls the logic statements between the entities as time advances. Accordingly, the simulation executive also functionally includes a central clock that tracks the time used in the simulation. The time advance may be based upon “time-slicing”, or fixed time intervals, or it may be based upon the occurrence of a next significant event. In either case, the simulation executive also includes one or more random number generators that are used to provide a stochastic behavior that mimics real processes. For example, scrap rates resulting from a process are rarely fixed, and generally vary between certain ranges. Accordingly, the scrap rate should be determined by a predetermined probability distribution, which may be a normal probability distribution. In a similar manner, variations resulting from cycle time-based differences, machine failures, machine efficiency variations, and other similar variations may be effectively simulated. The simulation executive is generally configured to order the execution of events within the simulation model. Accordingly, the simulation executive removes selected information from the flat file structure and builds (or populates) the logical statements for use in the simulation model. The simulation executive then extracts an event from the simulation model and executes the applicable logic statement. The procedure is successively repeated for each event until the end point of the modeled process is reached. In one particular embodiment of the invention, the DES engine 18 may comprise algorithms that are written in a high level programming language, and retained in a compiled form such as C⁺⁺. In another particular embodiment of the invention, the DES engine 18 may comprise the QUEST software package available from the Delmia Corporation of Auburn Hills, Mich., although other suitable alternatives exist.

The data generated by the DES engine 18 may be transferred to a graphics generation module 20 that formats the generated data to produce graphics files 22 that may be viewed on a visual display device (not shown in FIG. 1) that is coupled to the programmable computer. In one particular embodiment of the invention, a suitable graphics generation module 20 is the commercially available VISIO Technical 5.0 software package, available from the Microsoft Corporation of Redmond, Wash., although other suitable alternatives exist. In addition, the data generated by the DES engine 18 may be transferred to a text generation module 24 to appropriately format the data and produce text files 26 that may be similarly viewed on the visual display device coupled to the programmable computer. In still another particular embodiment of the invention, the text generation module 24 is commercially available as the TEXTPAD32 software package also available from Helios Software Solutions of Longbridge, England, although other alternatives exist.

FIG. 2 is a flowchart 30 that will be used to describe a method of analyzing a manufacturing process according to another embodiment of the invention. At block 32, a project file is created from process definition data 14 (FIG. 1), which generally includes various assembly related information, including informally created precedence networks. A process definition file results that is suitable for importation into the system 10 of FIG. 1. At block 34, the process definition file is stored for subsequent use in the analysis, and further to prevent loss of the process definition file. The process definition file typically includes an ordered definition of the tasks required to assemble and/or process a predetermined part, subassembly or complete assembly. Accordingly, the process definition file specifies overall start and end events for the process, and predecessor and successor tasks for task elements that are positioned between the start and end events. If a conflict between tasks in the process definition file an error may be generated to inform a user that a task conflict condition has been detected.

At block 36, the process definition file is transferred to the pre-processor module 16 (FIG. 1) to reconfigure process definition file into a flat file format, and then to the DES engine 18 (also shown in FIG. 1) to begin the creation of a model that will be used in the analysis. At block 38, resource data for the analysis is submitted and organized into a suitable file. The resource data typically includes information concerning manpower requirements and manpower availability, factory floor space availability, tooling requirements, as well as other resources required to assemble and/or process the part, subassembly or assembly. The resource data may be examined to determine if potential conflicts exist. For example, if a task requires a quantity of a particular resource greater than an amount that is currently available, an error is generated to inform a user that the simulation will be unable to process that task. The resource data may then be transferred to the DES engine 18 (FIG. 1) so that the compilation of the model may continue.

At block 40, schedule data is compiled, such as manufacturing dates and manufacturing days available for scheduling the process, a lot size for the process, a target completion date for the process, as well as other similar data. In addition, a learning curve for the process may be specified. Briefly and in general terms, a learning curve reflects the positive effect of increasing familiarity with the process. For example, a learning curve may be specified for labor that contributes to the performance of the process, which reflects the increasing familiarity of the labor with the tasks comprising the process. A learning rate may also be specified (as expressed as a percentage of the learning curve) that is based on a projected performance, a required performance, or alternately, upon actual historical data. The schedule data may then be transferred to the DES engine 18 and incorporated into the simulation model.

At block 42, the parameters for the model simulation are determined. The parameters may include the number of times the model is to be executed. Since variations may exist between successive model executions, it is advantageous to execute the model a number of times to determine mean values for the process. For example, a variability in cycle times, labor performance, and/or rework tasks may exist and be programmed into the model. Accordingly, statistical accuracy in the results generated by the model may require numerous executions of the model. The appropriate number of executions will depend on the variables employed in the model, as well as the discretion of the user. The variability in the model may stem from machine reliability, scrap rate variability, labor variability, as well as other known variables commonly associated with the performance of the tasks in the process. Variability may be expressed in terms of a statistical distribution, such as a Gaussian distribution if the errors are normally distributed. The variability may then controlled through random number generation. Accordingly, at block 42, one or more random “seed” values may be specified in order to control the variable processes.

Still referring to FIG. 2, the model compiled in the foregoing blocks of the method 30 is executed at block 44, and output data is generated that illustrates the behavior of the process over time, which includes variations in the process. The output data may be organized and formatted to present the output data in various forms. For example, task statistics may be compiled that documents a breakdown for the time required for each component task in the process, idle time associated with any component task, cycle time associated with a task, preempted time (for example, any time delay due to a scheduled work breaks), as well as other task statistics of interest. The output data may further be organized to document the utilization statistics for resources used in the process. For example, which resource is used by a component task, and the time period that the resource is required may be documented. In addition to strict numerical compilations of the output results, the task statistics and/or the resource utilization statistics may also be processed by the graphics generation module 20 (FIG. 1) to obtain a graphical representation of the output data.

At block 46, if it is desired to execute the same model, or, more importantly, to make changes to the existing model, a user may request additional executions of the same or different models by returning to block 34. If the exiting model is to be changed, selected portions of the existing model may be edited to achieve a new model that may be submitted to the DES engine 18 (FIG. 1). Otherwise, the method 30 may also terminate at block 46, whereupon the output data is stored.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A software-based system for analyzing a production process, comprising:
a first software module operable to receive process definition data for the production process and configured to organize the data into a suitable formatted input file that defines the process;
a second software module configured to receive the input file and populate one or more logical statements in a discrete event simulation model for the process, the second software module being further operable to perform the discrete event simulation and to generate an output file; and
a third software module operable to generate at least one user accessible file from the output file.

2. The system of claim 1, wherein the first software module further comprises a process definition module operable to receive precedence, task and resource information and to generate a file suitable for processing by the second processor.

3. The system of claim 2, wherein the first software module further comprises a pre-processor module operable to generate a flat file from input data.

4. The system of claim 1, wherein the second software module further comprises a discrete event simulation (DES) engine.

5. The system of claim 1, wherein the third software module further comprises a graphics module operable to generate a graphical output file, and text

6. A method of analyzing a manufacturing process, comprising;
receiving process definition data for the manufacturing process;
generating an input file from the process definition data;
populating one or more predetermined logical statements in a discrete event simulation model for the process;
processing the discrete event simulation model in a discrete event simulation (DES) engine to generate selected statistical data for the process; and
generating an output file that includes the selected statistical data.

7. The method of claim 6, wherein the process definition data further comprises precedence, task and resource information and wherein receiving the process definition data further comprises transferring the process definition data to a process definition module that generates the input file.

8. The method of claim 7, further comprising a pre-processor module, and further wherein transferring the process definition data comprises transferring the input file to the pre-processor to generate a flat input file.

9. The method of claim 6, wherein generating an input file further comprises saving the input file.

10. The method of claim 6, wherein processing the input file in a discrete event simulation (DES) engine further comprises compiling a model of the process.

11. The method of claim 6, wherein generating an output file further comprises creating at least one of a text file and a graphical file that includes the selected statistical data.
